(19) United States
(12) Patent Application Publication
(10) Pub. No.: US 2009/0057044 A1
(43) Pub. Date: Mar. 5, 2009

(54) Hydraulic Pump Unit For A Hydraulic Cab-Tilting Mechanism

(75) Inventor: Tone Oudelaar, Beuningen (NL)

Correspondence Address: QUARLES & BRADY LLP, 411 E. WISCONSIN AVENUE, SUITE 2040, MILWAUKEE, WI, 53202-4497, US

(73) Assignee: ACTUANT CORPORATION, Glendale, WI (US)

(21) Appl. No.: 11/664,472

(22) PCT Filed: Sep. 29, 2005
(86) PCT No.: PCT/NL2005/000705

§ 371 Date: Oct. 14, 2008

(30) Foreign Application Priority Data
Oct. 6, 2004 (NL) 1027186

(51) Int. Cl. B62D 33/07; F16K 35/00

(52) U.S. Cl. 180/89.15; 137/383

(57) ABSTRACT

A first aspect of the invention relates to a hydraulic pump unit (1) for feeding a hydraulic cab-tilting mechanism, comprising a casing (3) having at least two connecting ports (4,5) for the hydraulic cab-tilting mechanism, provided with a reservoir (6) for hydraulic fluid (7) and a hydraulic pump (8) which is connected to the reservoir and which can deliver hydraulic fluid to the connecting ports under working pressure required to operate the cab-tilting mechanism, a hydraulic circuit (9), fitted in the casing and connected to the connecting ports, the pump and the reservoir, and a hydraulic control valve (10) fitted in the hydraulic circuit, the hydraulic circuit further being provided with a mechanically-operable shut-off means (11), which, in the closed state, prevents the flow of hydraulic fluid under working pressure to the cab-tilting mechanism, which flow leads to operation of the cab-tilting mechanism. A second aspect of the invention relates to a hydraulic pump unit for feeding a hydraulic cab-tilting mechanism, comprising a casing having at leas t two connecting ports for the hydraulic cab-tilting mechanism, provid with a reservoir for hydraulic fluid and a hydraulic pump which is connected to the reservoir and which can deliver hydraulic fluid to the connecting g ports under working pressure required to operate the cab-tilting mechanism, a hydraulic circuit, fitted in the casing and connected to the connecting ports, the pump and the reservoir, and a hydraulic control valve fitted in the hydraulic circuit, the hydraulic circuit further being provided with a mechanic ally-operable shut-off means, which, in the closed state, prevents the flow of hydraulic fluid under working pressure to the cab-tilting mechanism, which flow leads to operation of the cab-tilting mechanism. A second aspect of the invention relates to a hydraulic pump unit for feeding a hydraulic cab-tilting mechanism, comprising a casing having a hydraulic pump, which is located in the casing and can be manually operated with a detachable pump lever, and a movable receiving member, located on the casing and connected to the pump, for receiving the pump lever, the receiving member being accompanied by a mechanical lock which can prevent the movement of the receiving member by s uring the receiving member relative to the casing.

### BACKGROUND OF THE INVENTION

A first aspect of the invention relates to a hydraulic pump unit for feeding a hydraulic cab-tilting mechanism, for example of a vehicle having a tilting cab. The hydraulic pump unit comprises a casing having at least two connecting ports for the hydraulic cab-tilting mechanism, provided with a reservoir for hydraulic fluid and a hydraulic pump which is connected to the reservoir and which can deliver hydraulic fluid to the connecting ports under working pressure required to operate the cab-tilting mechanism. In addition, the hydraulic pump unit comprises a hydraulic circuit, fitted in the casing and connected to the connecting ports, the pump and the reservoir, and a hydraulic control valve fitted in the hydraulic circuit between the pump and the connecting ports and having at least two valve positions, corresponding respectively to the tilting out of the driving position and the tilting-back into the driving position of the cab.

A hydraulic pump unit of this type is commonly known. When used in a vehicle having a cab provided with a hydraulic tilting cylinder, the pump unit is generally located in an easily accessible place. It would thus be easy even for an unauthorized person to operate the hydraulic pump unit, realized, for example, as a hand pump, and hence to make the cab tilt. Proposals have already been made for protection against operation by unauthorized persons.

Protective systems are known in which electromagnetic valves are fitted in the hydraulic circuit. Such valves can only be opened by actuation, for example from the cab, in order subsequently to be able to operate the tilting cylinder with the aid of the pump unit. For this, the fitting of electric wiring between the pump unit and the actuating mechanism, for example in the cab, is necessary, which is unattractive, inter alia owing to interference problems and from the cost perspective.

An alternative protective system is described in EP 0583039. In this, a handle which operates the control valve and which protrudes beyond the casing is provided with a key-operated lock cylinder. In the closed state, the handle can no longer be turned, whereby the control valve is fixed.

A disadvantage of this solution is that the pump can still be operated, whereby tilting out of the driving position of the vehicle or tilting-back into the driving position remains possible. Consequently, unsafe situations remain possible: for example, if someone or something is present in the position towards which tilting can still be effected. Another disadvantage of this solution is the susceptibility to sabotage: if the connections of the hydraulic cab-tilting mechanism to the connecting ports of the pump unit are changed, a movement of the tilting cab in the unwanted direction still remains possible.

### SUMMARY OF THE INVENTION

The object of the first aspect of the invention is to provide a hydraulic pump unit of the abovementioned sort having an alternative protective system.

According to the invention, this object is achieved by the fact that the hydraulic circuit further is provided with a mechanically operable shut-off means, which, in the closed state, prevents the flow of hydraulic fluid under working pressure to the cab-tilting mechanism, which flow leads to operation of the cab-tilting mechanism.

In a preferred embodiment, the mechanically operable shut-off means is employed in a branch line of the hydraulic circuit to the reservoir. The shut-off means can open up the branch line in the closed state, so that, in the closed state, hydraulic fluid under less than the working pressure is fed to the two connecting ports. The pressure of the hydraulic fluid which is fed to the connecting ports is limited, since this pressure, if the shut-off means is in the open position, can never be higher than the reservoir pressure. Generally, this reservoir pressure cannot be higher than about 5 bar. The working pressure of such a system which is necessary to tilt a cab-tilting mechanism is typically around 280 bar. This pressure is necessary to make the cylinder move in or out. Preferably, the branch line of the hydraulic circuit is located between the pump and the control valve. If pumping is effected while the shut-off means is in the open state, the hydraulic fluid flows from the reservoir, through the pump, through the branch line and along the shut-off means back into the reservoir. If the shut-off means is closed, the fluid will flow out of the reservoir, through the pump and through the hydraulic circuit to the control valve, and from there to a cylinder which can tilt the tilting mechanism.

In an alternative preferred embodiment, the mechanically operable shut-off means, in the closed state, prevents the supply of hydraulic fluid from the pump to both connecting ports. In this case, an excess pressure valve has to be accommodated in the hydraulic circuit. More advantageously, the mechanically operable shut-off means is employed in the hydraulic circuit between the pump and the control valve.

In another alternative preferred embodiment, the mechanically operable shut-off means, in the closed state, prevents flow along at least one connecting port.

Preferably, the mechanically operable shut-off means comprises a ball, which is to be placed in the hydraulic circuit. This can be simply and advantageously realized in existing pump units.

Preferably, the ball can be operated by means of a pin which can displace the ball to some extent, for example out of a seat for the ball. Such a pin forms part of a mechanical lock, for example a cylinder lock. This lock can be fitted in the casing of the pump unit, or in a separate, own housing next to the pump unit. In the latter case, the pin is preferably employed between the housing of the cylinder lock and the casing of the pump unit, through which casing the pin juts in order to be able to displace the ball. The cylinder lock can preferably be operated by means of a key, for which a keyhole is present on the outside of the housing of the cylinder lock. If the mechanical lock is located in the casing of the pump unit, the keyhole is preferably fitted on the outside of this housing. A mechanical lock of this type enables a simple operation of the shut-off means and prevents misuse by third parties.

A second aspect of the invention relates to a hydraulic pump unit for feeding a hydraulic cab-tilting mechanism, for example of a vehicle having a tilting cab. The hydraulic pump unit comprises a casing having at least two connecting ports for the hydraulic cab-tilting mechanism and provided with a reservoir for hydraulic fluid. In addition, the hydraulic pump unit comprises a hydraulic pump, which is located in the casing and can be manually operated with a detachable pump lever, and a movable receiving member, located on the casing and connected to the pump, for receiving the pump lever.

It is known to make the working of the pump impossible for unauthorized persons by locking the pump lever by means of a (pad)lock. It is also known to make the insertion of the pump lever into the receiving member impossible by the fitting of a lock.

A disadvantage of this solution is that the receiving member itself is still movable. If an alternative pump lever is used, which can move the receiving member, the pump can be operated and the tilting cab tilted.

The object of the second aspect of the invention is to provide a hydraulic pump unit of the abovementioned sort, having an alternative protective system.

According to the invention, this object is achieved by the fact that the receiving member is accompanied by a mechanical lock which can prevent the movement of the receiving member by securing the receiving member relative to the casing. Since any movement of the receiving member is barred, such a protective system is hard to sabotage by the use of cutters or the like.

Preferably, the lock is a loose part which can be inserted in the receiving member so that it is impossible to place the pump lever in the receiving member when the lock is placed therein. Preferably, a locking member of the lock catches behind a clasp connected to the casing, so that movement of the lock out of the receiving member is only possible following movement of the locking member. Preferably, this is only possible with the aid of a key.

The invention is explained in greater detail below using two illustrative embodiments with reference to the drawing, in which:

### BRIEF DESCRIPTION OF THE DRAWINGS

FIG. 1 shows a hydraulic pump unit according to the first aspect of the invention,

FIGS. 2a and 2b show in detail an illustrative embodiment of a mechanically operable shut-off means,

FIG. 3 shows an alternative embodiment of a mechanical lock,

FIG. 4 shows a hydraulic diagram of a first alternative embodiment of the invention,

FIG. 5 shows a hydraulic diagram of a second alternative embodiment of the invention,

FIG. 6a shows in front view a hydraulic pump unit according to the second aspect of the invention,

FIG. 6b shows the hydraulic pump unit of FIG. 6a in side view,

FIGS. 7a and 7b show the hydraulic pump unit of FIGS. 6a and 6b with, accommodated therein, a mechanical lock according to the second aspect of the invention.

### DETAILED DESCRIPTION OF THE PREFERRED EMBODIMENT

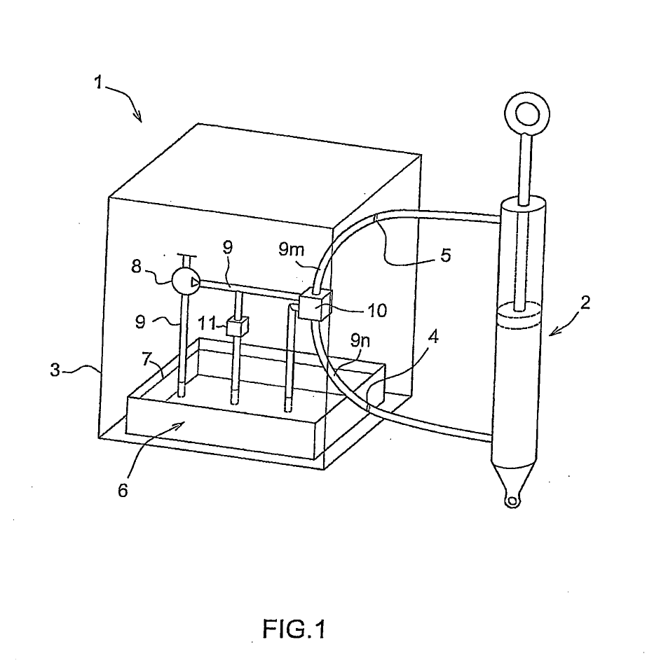

FIG. 1 shows a hydraulic pump unit 1 for feeding a hydraulic cylinder 2 according to the first aspect of the invention. For example, this hydraulic cylinder 2 is part of a cab-tilting mechanism of a vehicle having a tilting cab (not shown). The pump unit 1 comprises a casing 3 having two connecting ports 4 and 5 for connecting the pump unit 1 to the cylinder 2. The casing 3 is provided with a reservoir 6 for hydraulic fluid 7 and a hydraulic pump 8 connected to the reservoir 6. A hydraulic circuit 9 is fitted in the casing 3 and is connected to the connecting ports 4 and 5, the pump 8 and the reservoir 6. In the hydraulic circuit 9 there is fitted a hydraulic control valve 10. With the aid of this control valve, the flow of the hydraulic fluid to part 9m or 9n of the hydraulic circuit 9 can be controlled and the cylinder 2 operated, so that a tilting cab connected to the cylinder 2 can move between at least two working positions, corresponding respectively to the tilting out of the driving position and the tilting-back into the driving position of the vehicle. The hydraulic circuit 9 is further provided with a mechanically operable shut-off means 11, which can block or open up a branch line of the hydraulic circuit to the reservoir between the pump 8 and the control valve 10.

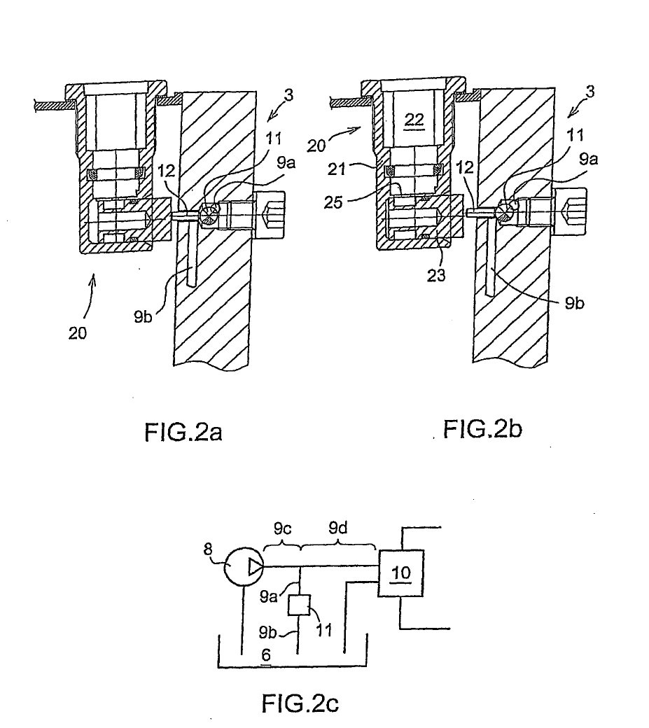

FIGS. 2a and 2b show in detail an illustrative embodiment of a mechanically operable shut-off means 11 in the casing 3. Parts 9a and 9b of the hydraulic circuit are represented. For example, the mechanical shut-off means 11 is employed in a branch line of the hydraulic circuit, as is represented in the hydraulic diagram in FIG. 2c. The hydraulic circuit comprises two parts 9c and 9d between the pump 8 and the control valve 10. Located between parts 9c and 9d there is a branch line, comprising parts 9a and 9b, to the reservoir 6. Located between the part of the branch line 9a which is connected to the parts 9c and 9d and the part of the branch line 9b which is connected to the reservoir 6 there is the mechanical shut-off means 11. The mechanical shut-off means 11 comprises a ball. The ball 11 is movable by means of a pin 12, which cooperates with a mechanical lock 20. In the situation shown in FIG. 2a, the ball 11 is in such a position that flow of hydraulic fluid from the pump 8, through the part 9c, and through the part 9a to the part of the circuit 9b around the ball 11 and the pin 12 is possible. In the situation shown in FIG. 2b, the ball 11 is located before the part of the hydraulic circuit 9b and there is no flow possible of the hydraulic fluid to that part. The hydraulic fluid will then flow from the pump 8 via parts 9c and 9d to the control valve 10. The lock 20 comprises a separate housing 21, in which a lock cylinder 22 having a keyhole is fitted to receive a key (not represented). When the key is turned, an eccentric cam 25 turns, whereby a slide 23 connected thereto shifts the pin 12 between the housing 21 and the casing 3, which pin 12 operates the mechanical shut-off means 11.

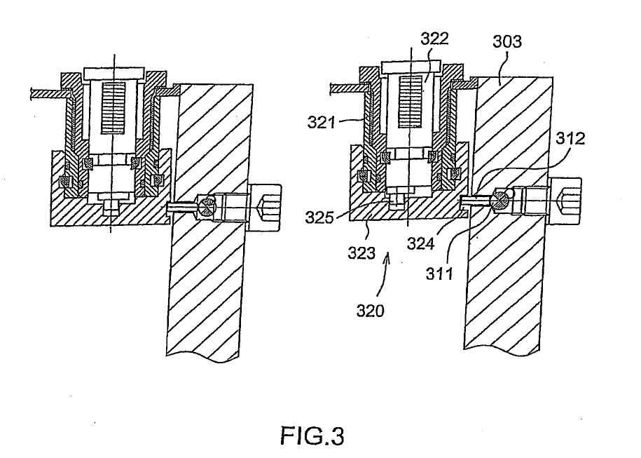

In FIG. 3, an alternative embodiment of a mechanical lock 320 is shown. The mechanical lock 320 comprises an own housing 321, in which a lock cylinder 322 having a keyhole is fitted to receive a key (not represented). When the key is turned, an eccentric cam 325 turns, whereby a rotatable element 323 connected thereto turns. The rotatable element 323 has a depth-variable groove 324, which shifts the pin 12 between the housing 21 and the casing 3, which pin 12 operates the mechanical shut-off means 11. The mechanical shut-off means 311 works the same as the mechanical shut-off means 11 shown in FIG. 2.

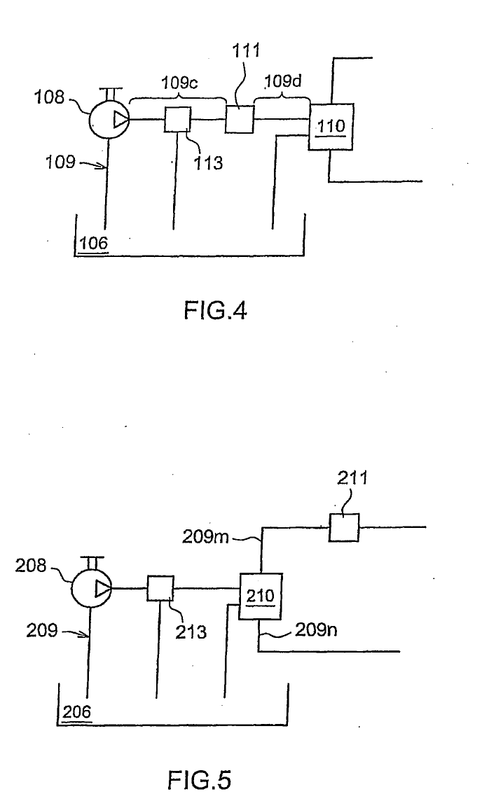

In FIG. 4, a hydraulic diagram of a first alternative embodiment of the invention is shown, wherein a mechanically operable shut-off means 111 is fitted in a hydraulic circuit 109 between a part of the circuit 109c which is connected to a pump 108 and a part of the circuit 109d which is connected to a control valve 110. When the shut-off means 111 is open, the hydraulic fluid will flow from the pump 108 to the control valve 110. When the shut-off means 111 is closed, hydraulic fluid will collect in the part 109c between the pump 108 and the shut-off means 111. In order to prevent excess pressure in this part, an excess pressure valve 113 is fitted in this part.

FIG. 5 shows a hydraulic diagram of a second alternative embodiment of the invention, wherein a shut-off means 211 is fitted in a part 209m of a hydraulic circuit 209 after the pump 208 and after the control valve 210 and leading to a connecting port (not represented). In order to prevent excess pressure in this part 209m, an excess pressure valve 213 is accommodated in this part.

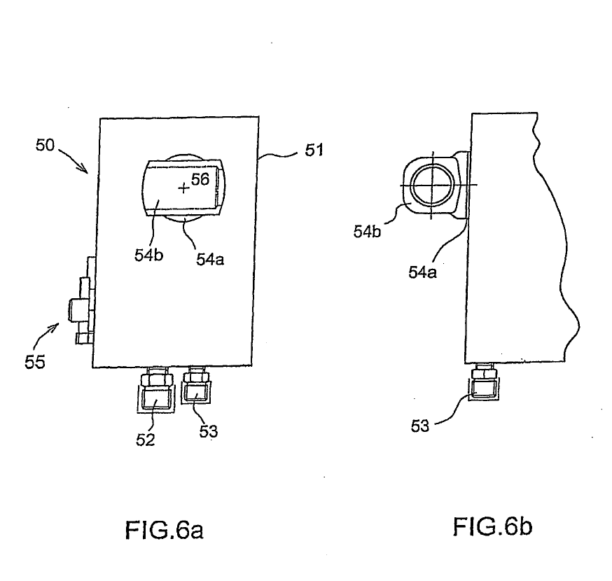

FIG. 6a shows in front view a hydraulic pump unit 50 for feeding a hydraulic cab-tilting mechanism according to the second aspect of the invention. The pump unit 50 has a casing 51 having two connecting ports 52 and 53 for the hydraulic cab-tilting mechanism. Located in the casing are a reservoir (not shown) for hydraulic fluid and a hydraulic pump (not shown). Located on the casing is a receiving member 54 which is movable about an axis 56 and is connected to the pump and in which there can be received a detachable pump lever (not shown), by which the pump can be manually operated. For example, the pump lever and the receiving member can be rotated over an angle of 50° about the axis 56. The receiving member consists of a part 54a, which is connected to the pump through the casing 51, and a sleeve-shaped part 54b, in which the pump lever can be received. In addition, an operating member for a control valve 55 can be represented.

FIG. 6b shows the hydraulic pump unit 50 of FIG. 6a in side view. The sleeve-shaped part 54b of the receiving member is clearly evident from this.

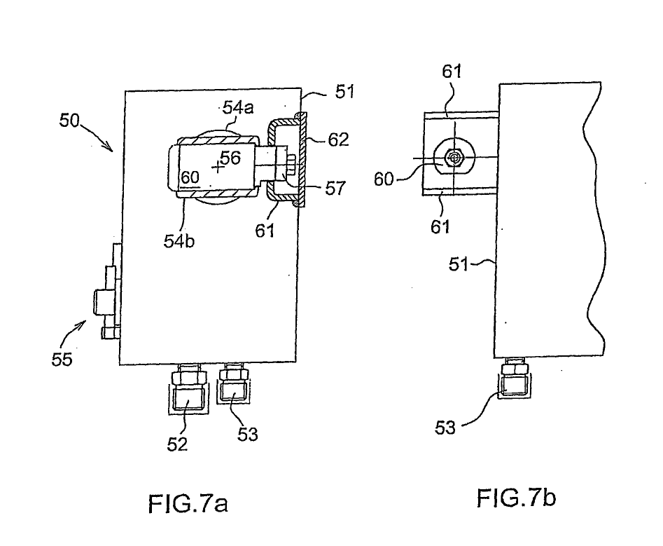

FIGS. 7a and 7b show the hydraulic pump unit 50 of FIGS. 6a and 6b with the casing 51, the two connecting ports 52 and 53 for the hydraulic cab-tilting mechanism and a control valve 55. In the sleeve-shaped part 54b of the receiving member there is accommodated a mechanical lock 60, which can prevent the movement of the receiving member by securing the receiving member 60 relative to the casing. The mechanical lock 60 can be connected to a clasp 61 which is welded to a plate 62 on the housing 51. The mechanical lock 60 is here a cylinder lock which can be operated with a key. When the key is turned, a locking member 57 catches behind the clasp 61. For the operation of the pump, the lock must first be removed, after which the pump lever can be inserted in the receiving member.

1. Hydraulic pump unit for feeding a hydraulic cab-tilting mechanism, comprising:
a casing having at least two connecting ports for the hydraulic cab-tilting mechanism, provided with a reservoir for hydraulic fluid and a hydraulic pump which is connected to the reservoir and which can deliver hydraulic fluid to the connecting ports under working pressure required to operate the cab-tilting mechanism,
a hydraulic circuit, fitted in the casing and connected to the connecting ports, the pump and the reservoir,
a hydraulic control valve fitted in the hydraulic circuit between the pump and the connecting ports and having at least two valve positions, corresponding respectively to the tilting out of the driving position and the tilting-back into the driving position of the cab,
characterized in that
the hydraulic circuit further is provided with a mechanically operable shut-off means, which, in the closed state, prevents the flow of hydraulic fluid under working pressure to the cab-tilting mechanism, which flow leads to operation of the cab-tilting mechanism.

2. Hydraulic pump unit according to claim 1, wherein the mechanically operable shut-off means can block a branch line of the hydraulic circuit to the reservoir or, in the closed state, opens up the same, so that, in the closed state, hydraulic fluid under less than the working pressure is fed to the two connecting ports.

3. Hydraulic pump unit according to claim 2, wherein the branch line of the hydraulic circuit is located between the pump and the control valve.

4. Hydraulic pump unit according to claim 1, wherein the mechanically operable shut-off means, in the closed state, prevents the supply of hydraulic fluid from the pump to both connecting ports.

5. Hydraulic pump unit according to claim 4, wherein the mechanically operable shut-off means is employed in the hydraulic circuit between the pump and the control valve.

6. Hydraulic pump unit according to claim 1, wherein the mechanically operable shut-off means, in the closed state, prevents flow along at least one connecting port.

7. Hydraulic pump unit according to claim 1, wherein the mechanically operable shut-off means comprises a ball.

8. Hydraulic pump unit according to claim 1, wherein the mechanically operable shut-off means comprises a movable pin, which cooperates with a mechanical lock.

9. Hydraulic pump unit according to claim 8, wherein the mechanical lock can be operated by means of a key.

10. Hydraulic pump unit according to claim 9, wherein the key can be received in a keyhole located on the outside of the casing.

11. Hydraulic pump unit according to claim 8, wherein the mechanical lock is located in a separate housing, the pin being located between the housing of the mechanical lock and the casing of the hydraulic pump unit.

12. Hydraulic cab-tilting mechanism, fed by a hydraulic pump unit according to claim 1.

13. Vehicle having a cab-tilting mechanism provided with a hydraulic pump unit according to claim 1 for feeding the cab-tilting mechanism.

14. Hydraulic pump unit for feeding a hydraulic cab-tilting mechanism, comprising:
a casing having at least two connecting ports for the hydraulic cab-tilting mechanism and provided with a reservoir for hydraulic fluid,
a hydraulic pump, which is located in the casing and can be manually operated with a detachable pump lever,
a movable receiving member, located on the casing and connected to the pump, for receiving the pump lever,
characterized in that
the receiving member is accompanied by a mechanical lock which can prevent the movement of the receiving member by securing the receiving member relative to the casing.

15. Hydraulic pump unit according to claim 14, wherein the mechanical lock can prevent the reception of the pump lever.

16. Hydraulic pump unit according to claim 14, wherein the mechanical lock can be operated with a key.

17. Hydraulic pump unit according to claim 14, wherein the mechanical lock is a loose part.

18. Hydraulic pump unit according to claim 17, wherein the mechanical lock can be inserted in the receiving member.

19. Hydraulic pump unit according to claim 14, wherein the mechanical lock is connected to the casing.

20. Hydraulic cab-tilting mechanism, fed by a hydraulic pump unit according to claim 14.

21. Vehicle having a cab-tilting mechanism provided with a hydraulic pump unit according to claim 14 for feeding the cab-tilting mechanism.
